(19) United States
(12) Patent Application Publication
(10) Pub. No.: US 2015/0176989 A1
(43) Pub. Date: Jun. 25, 2015

(54) Accelerometer-Based Hill Angle Estimation

(71) Applicant: HTI IP, LLC, ATLANTA, GA (US)

(72) Inventors: Stephen Christopher Welch, ATLANTA, GA (US); JAMES RONALD BARFIELD, JR., ATLANTA, GA (US)

(73) Assignee: HTI IP, LLC, ATLANTA, GA (US)

(21) Appl. No.: 14/139,726

(22) Filed: Dec. 23, 2013

(51) Int. Cl. G01C 9/02; G01P 15/02; G06F 17/17; G01C 21/26

(52) U.S. Cl. CPC G01C 9/02; G01C 21/26; G01P 15/02; G06F 17/17

(57) ABSTRACT

The embodiments disclosed are directed to systems and methods for determining the inclination of a surface beneath a vehicle. In some embodiments, a method uses an accelerometer to determine a final surface inclination value. The final surface inclination value can then be used to compensate for the acceleration of the vehicle caused by gravity. The method includes receiving accelerometer values from the accelerometer. The method also includes determining surface inclination values based on the accelerometer values. The method further includes storing the surface inclination values. And the method includes applying a digital filter to the stored surface inclination values to determine a final surface inclination value.

### BACKGROUND INFORMATION

Accelerometers are devices used to measure acceleration and can be used with vehicles to sense movement of the vehicle. Accelerometers can measure acceleration along three orthogonal axes. Depending on the orientation of the accelerometer mounted in the vehicle and the angle of inclination of the surface beneath the vehicle, acceleration caused by gravity can affect the acceleration measurements on one or more accelerometer axes. Further, the effect of acceleration caused by gravity can vary during the course of a typical drive as the vehicle travels up and down hills.

### BRIEF DESCRIPTION OF THE DRAWINGS

FIG. 1 shows a diagram illustrating an exemplary overview of the embodiments of the present disclosure.

FIG. 2A is a block diagram of a first exemplary system for determining the inclination of a surface, consistent with embodiments of the present disclosure.

FIG. 2B is a block diagram of a second exemplary system for determining the inclination of a surface, consistent with embodiments of the present disclosure.

FIG. 3 is a block diagram of an exemplary device for determining the inclination of a surface, consistent with embodiments of the present disclosure.

FIG. 4 is a flowchart illustrating an exemplary method for determining a final surface inclination value, consistent with embodiments of the present disclosure.

FIG. 5 is a flowchart illustrating an exemplary method for determining one or more final surface inclination values and one or more transformed acceleration values, consistent with embodiments of the present disclosure.

FIG. 6 is a flowchart illustrating an exemplary method for determining one or more inclination-compensated acceleration values, consistent with embodiments of the present disclosure.

FIGS. 7A-7C illustrate exemplary charts according to a sample set of acceleration values, consistent with embodiments of the present disclosure.

FIG. 8 is a flowchart illustrating an exemplary method for determining coefficients of a digital filter used in determining a final surface inclination value, consistent with embodiments of the present disclosure.

FIG. 9 is a flowchart illustrating an exemplary method for creating a sample model using sample surface inclination values for use in the creation of a digital filter, consistent with embodiments of the present disclosure.

FIG. 10 is an exemplary chart illustrating a sample model created by a Gaussian Process fitted to a sample set of surface inclination values, consistent with embodiments of the present disclosure.

FIG. 11 is a flowchart illustrating an exemplary method for recording sample accelerometer values and GPS values for use in developing the digital filter and sample model, consistent with embodiments of the present disclosure.

### DETAILED DESCRIPTION OF THE DRAWINGS

Reference will now be made in detail to the exemplary preferred embodiments illustrated in the accompanying drawings. Whenever possible, the same reference numbers will be used throughout the drawings to refer to the same or like parts.

The embodiments described herein relate to using an accelerometer, alone or in combination with other sensors, to determine a value of the inclination of a surface beneath a vehicle. The value can then be used to compensate for the acceleration of the vehicle caused by gravity. Compensating for acceleration caused by gravity can more accurately determine the acceleration (whether it's a positive or negative value) of the vehicle caused by operator behavior.

For example, using an accelerometer in a vehicle can help determine the vehicle's acceleration on a hill with respect to the hill's inclination. This determination can assist with more accurately determining driver aggressiveness for usage-based insurance (UBI) applications and adjusting insurance rating/scoring models. UBI aggression metrics can be based on measured acceleration values on one or more accelerometer axes. The inclination of the surface beneath the vehicle can influence the acceleration values needed to compute aggression metrics, potentially reducing the effectiveness of these metrics. Accordingly, as described in the some embodiments herein, evaluating the acceleration with respect to the inclination can provide more accurate results.

Also, it is appreciated that the embodiments described herein are not limited to determining UBI aggression metrics. As additional examples, the embodiments described herein can be used to help determine how to maximize vehicle fuel efficiency or to determine the optimal braking force or to determine the optimal transmission gear.

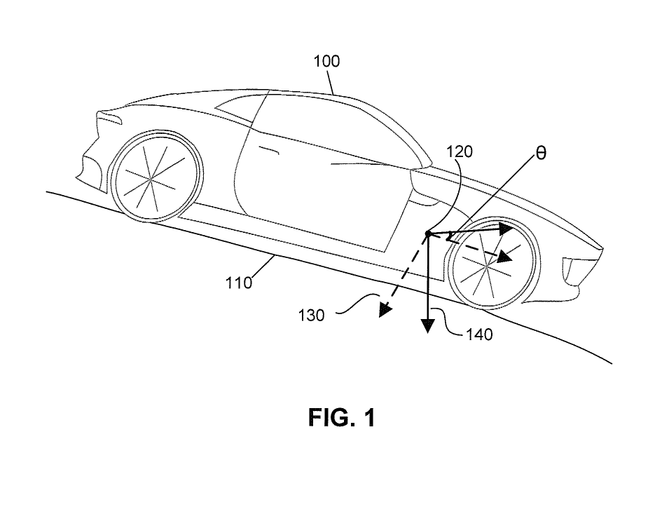

FIG. 1 shows a diagram illustrating an exemplary overview of the embodiments of the present disclosure. As shown in FIG. 1, a vehicle 100 can be disposed on a surface 110. Vehicle 100 can be, for example, an automobile, bicycle, motorcycle, all-terrain vehicle, train, watercraft, plane, or any other form of transportation that accelerates with either a positive or negative value (also known as decelerates). Vehicle 100 can further have a coordinate frame 130 consisting of multiple axes, including an axis in the direction of travel of vehicle 100 and an axis orthogonal to the direction of travel of vehicle 100, pointing down toward the Earth.

Surface 110 can be, for example, a road, field, path, track, water, runway, or any other surface upon which a vehicle is capable of traveling. Surface 110 further can have a surface inclination (θ) representing, for example, an incline, angle, slope, pitch, or gradient of surface 110. For example, the surface inclination (θ) can be a hill or a ramp. In some embodiments a surface inclination value can correspond to an estimate of the surface inclination (θ). The surface inclination value can be expressed as an angle, percentage, slope, or ratio. In some embodiments, the surface inclination value can represent the difference in degrees between vehicle coordinate frame 130 and gravitational coordinate frame 140. In these embodiments, the surface inclination value can range between negative ninety degrees and positive ninety degrees.

In some embodiments, an accelerometer 120 can be located in or on vehicle 100. For example, accelerometer 120 can be mounted inside the engine bay of vehicle 100, mounted on vehicle 100, or mounted elsewhere inside or outside of vehicle 100. Accelerometer 120 can be installed during the manufacture of vehicle 100 or can be later installed, for example, as an aftermarket device. As described in further detail below, in some embodiments, accelerometer 120 can be integrated with an analysis component to form a single integrated unit. This integrated unit, including accelerometer 120, can then be operatively coupled to vehicle 100. In some embodiments, accelerometer 120 can be located on a person that is inside or using vehicle 100. For example, accelerometer 120 could be located in a phone, a smart watch, or any other device that includes an accelerometer and that can be carried by the person.

Accelerometer 120 further can be a three-axis accelerometer capable of measuring, in some embodiments, coordinate acceleration values on three orthogonal axes. Additionally, in some embodiments, accelerometer 120 can measure proper acceleration values. In some embodiments, the axes of accelerometer 120 can be physically aligned with the axes of vehicle coordinate frame 130 when accelerometer 120 is located in or on vehicle 100. In other embodiments, acceleration values obtained by accelerometer 120 can be aligned with vehicle coordinate frame 130 using the techniques described by co-pending U.S. application Ser. No. 13/936,120, titled “Automatic Alignment of a Vehicle Three Axes Accelerometer,” which is hereby incorporated by reference. After being aligned, acceleration values obtained by accelerometer 120 can correspond to acceleration in the direction of travel of vehicle 100 (hereinafter “inline acceleration” or “a_{y}”) and acceleration orthogonal to the direction of travel of vehicle 100, pointing down toward the Earth (hereinafter “orthogonal acceleration” or “a_{z}”), as indicated by vehicle coordinate frame 130.

When the surface inclination value is nonzero, acceleration caused by gravity can have an effect on both the inline and orthogonal accelerations of vehicle 100. Moreover, the effect on inline and orthogonal acceleration can vary with the value of the surface inclination. Acceleration values obtained by accelerometer 120 can be analyzed, alone or in combination with other sensors, to determine the surface inclination value. For example, the inline acceleration, a_{y}, and the orthogonal acceleration, a_{z}, can be used to calculate the surface inclination value. The surface inclination value can be stored and a digital filter can be applied to the stored values to determine a final surface inclination value.

After the final surface inclination value is determined, a method can then compensate for the acceleration caused by the surface inclination (θ). In some embodiments, a method can compensate for acceleration caused by the surface inclination (θ) to determine, among other things, acceleration caused by operator behavior. More accurate information showing operator behavior can then be used to more accurately provide information showing driver aggressiveness.

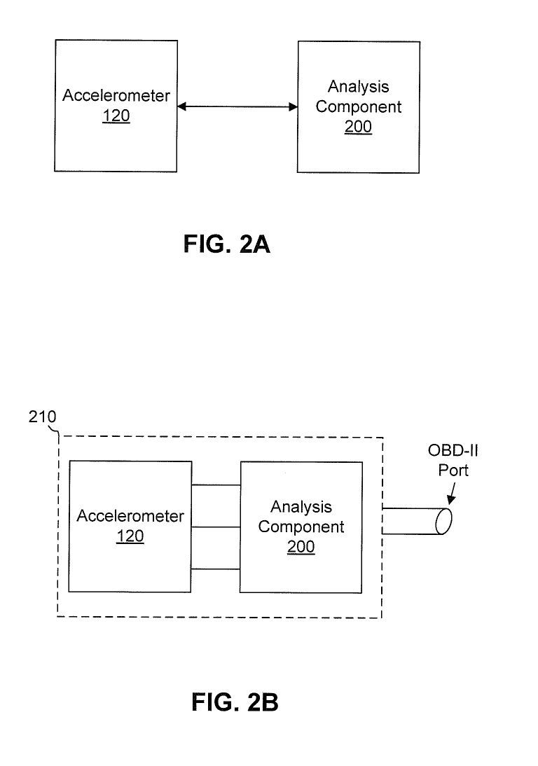

FIG. 2A is a block diagram of a first exemplary system for determining the inclination of a surface, consistent with embodiments of the present disclosure. As shown in FIG. 2A, accelerometer 120 can be coupled with analysis component 200. Accelerometer 120 can communicate with analysis component 200 through any wired communication interface, such as, for example, an Ethernet interface or a USB interface.

FIG. 2B is a block diagram of a second exemplary system for determining the inclination of a surface, consistent with embodiments of the present disclosure. In contrast to FIG. 2A, FIG. 2B illustrates that accelerometer 120 and analysis component 200, in addition to other components, can form a single integrated unit 210. In some embodiments, integrated unit 210 of FIG. 2B can be operatively coupled to vehicle 100. For example, integrated unit 210 can be connected to an onboard diagnostic II (OBD-II) port in vehicle 100 to obtain power and/or vehicle diagnostic information. Vehicle diagnostic information can be provided, for example, over a CAN bus. In some embodiments, integrated unit 210 can be operatively coupled to vehicle 100 through the use of wireless technology such as, for example, cellular, Bluetooth, or other short range or long range communication schemes. And in some embodiments, integrated united 210 can use wireless technology to transmit the final surface inclination value or any other value determined in any of the methods, consistent with the embodiments of the present disclosure, to other devices.

In some embodiments, analysis component 200 of FIGS. 2A-2B can include one or more processors and computer readable media, an application specific integrated circuit (ASIC), or other circuitry designed to calculate a final surface inclination value. The computer readable media can be any non-transitory computer readable media storing instructions that when executed by the one or more processors cause the processors to execute one of the methods, consistent with the embodiments of the present disclosure. For example, analysis component 200 can be a laptop, phone, smart watch, or any other computing device.

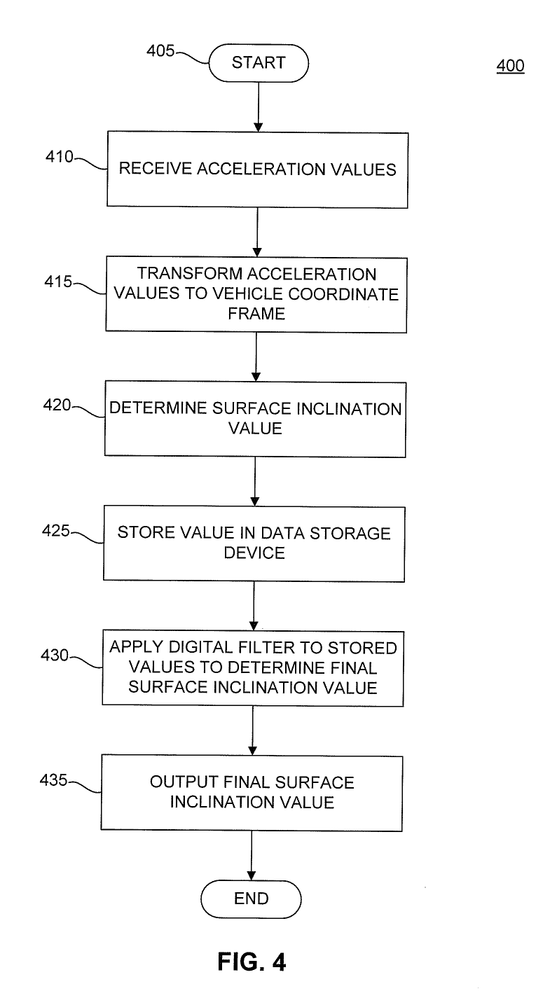

The analysis component 200 shown in FIGS. 2A and 2B can determine a final surface inclination value, as described in FIG. 4 below. Analysis component 200 can transform acceleration values received from accelerometer 120 to align those values with the axes of vehicle coordinate frame 130. In some embodiments, analysis component 200 can store a plurality of surface inclination values and apply a digital filter to the stored values to determine a final surface inclination value. And in some embodiments, analysis component 200 can use the final surface inclination value to calculate inclination-compensated acceleration values.

Moreover, in some embodiments, analysis component 200 can determine filter coefficients to be used in determining the final surface inclination value. In some embodiments, analysis component 200 can create a model of surface inclination values using non-accelerometer-based inclination values. And analysis component 200 can record training data for use in developing the model of surface inclination values. All of these functions and capabilities are described in further detail below.

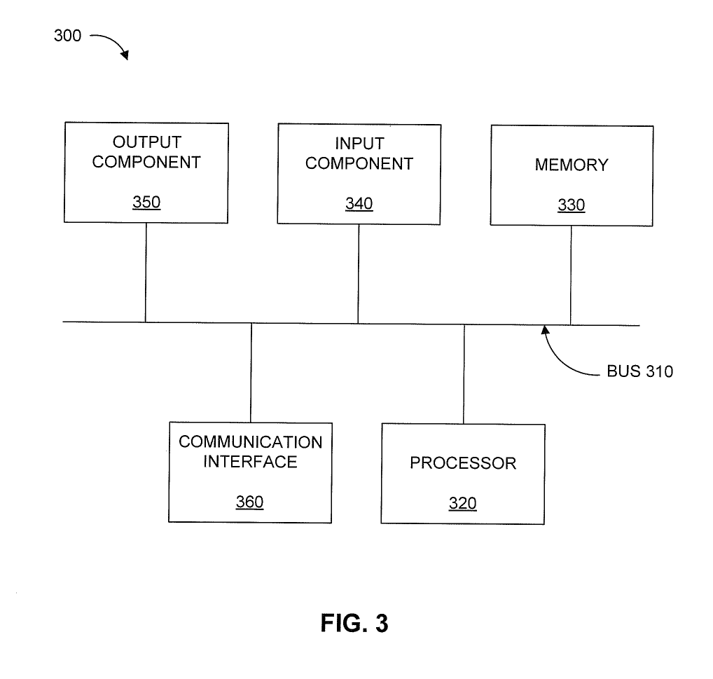

FIG. 3 is a block diagram of an exemplary device 300 for determining the inclination of a surface, consistent with embodiments of the present disclosure. In some embodiments, device 300 can incorporate an analysis component (e.g. analysis component 200 as described in FIGS. 2A and 2B). In some embodiments, device 300 can receive information from the analysis component 200. Device 300 can include one or more components such as bus 310, processor 320, memory 330, input component 340, output component 350, and communication interface 360. While FIG. 3 shows device 300 having these several components, it is appreciated that device 300 can have additional, fewer, different, or differently arranged components.

As shown in FIG. 3, bus 310 can include one or more communication paths that permit communication between the components of device 300. Processor 320 can include one or more processors, one or more microprocessors, or processing logic that can interpret and execute instructions stored in memory 330 and/or stored internally within processor 320. In some embodiments, memory 330 can include any type of dynamic storage device that can store information and instructions for execution by processor 320. Alternatively, in some embodiments, memory 330 can include any type of non-volatile storage device that can store information for use by processor 320. And in some embodiments, memory 330 can include both a type of dynamic storage device and a type of non-volatile storage device.

Input component 340 can include a mechanism that permits a user to input information to device 300. For example, input component 340 can include any combination of a keyboard, a keypad, a button, a switch, a touchscreen, and/or any other device that can provide input or can be an interface for communicating with any of those devices. Output component 350 can include a mechanism that provides information to a user. For example, output component can be a display, a speaker, one or more light emitting diodes, and/or any other device that can output information or can be an interface for communicating with any those devices.

Communication interface 360 can include any transceiver-like mechanism that enables device 300 to communicate with other devices and/or systems. For example, in some embodiments, communication interface 360 can include an Ethernet interface, an optical interface, a coaxial cable, or any other wired communication interface. In some embodiments, communication 360 can include a wireless communication component, such as an infrared receiver, a Bluetooth radio, cellular modem, or any other wireless device capable short range or long range communication scheme. The wireless communication component can further be coupled to an external device, such as a remote control, a wireless keyboard, a mobile telephone, a server, or similar device. In some embodiments, device 300 can include more than one communication interface 360. For example, device 300 can include an optical interface and an Ethernet interface.

The device 300 shown in FIG. 3 can determine a final surface inclination value, as described in FIG. 4 below. Device 300 can transform acceleration values received from accelerometer (e.g. accelerometer 120 as described in FIG. 1) to align those values with the axes of a vehicle coordinate frame (e.g. vehicle coordinate frame 130 as described in FIG. 1). In some embodiments, device 300 can store a plurality of surface inclination values and apply a digital filter to the stored values to determine the final surface inclination value. And in some embodiments, device 300 can use the final surface inclination value to calculate inclination-compensated acceleration values.

Moreover, in some embodiments, device 300 can determine filter coefficients to be used in determining the final surface inclination value. In some embodiments, device 300 can create a model of surface inclination values using non-accelerometer-based inclination values. And device 300 can record training data for use in developing the model of surface inclination values. All of these functions and capabilities are described in further detail below.

Device 300 can perform these functions and capabilities in response to processor 320 executing software instructions stored in a computer-readable medium, such as memory 330. A computer-readable medium can be a non-transitory memory device. A non-transitory memory device can include space within a single physical memory device or can be spread across multiple physical memory devices. The software instructions can be read into memory 330 from another computer-readable medium or from another device. The software instructions stored in memory 330 can cause processor 320 to perform the methods, consistent with the embodiments of the present disclosure. Moreover, the embodiments of the present disclosure are not limited to any specific combination of hardware circuitry and software.

FIG. 4 is a flowchart illustrating an exemplary method 400 for determining a final surface inclination value, consistent with embodiments of the present disclosure. The illustrated method is not exhaustive and can be altered to delete steps or further include additional steps. Method 400 can be performed, for example, by an analysis component (e.g., analysis component 200 as described in FIGS. 2A and 2B), by a device incorporating or receiving information from an analysis component (e.g., device 300 as described in FIG. 3), other devices, or any combination thereof. For purposes of simplicity and without limiting the scope of disclosure, method 400 will be described as being performed by the device. After initial start step 405, the device can receive acceleration values (410) from an accelerometer (e.g., accelerometer 120). The received acceleration values can be the coordinate accelerations values.

After receiving the acceleration values, in some embodiments, the device can transform the acceleration values (415) by aligning the received acceleration values with the axes of a vehicle coordinate frame (e.g., vehicle coordinate frame 130). In some embodiments, the transformation step 415 is not needed. For example, a transformation step may not be needed if the axes of the accelerometer are already physically aligned with the axes of the vehicle coordinate frame. The transformed acceleration values can correspond to the inline acceleration (a_{y}) and the orthogonal acceleration (a_{z}) of vehicle 100, further described above.

At some time thereafter, the device determines a surface inclination value (420). To determine the surface inclination value, the device can compute the arctangent of the inline acceleration (a_{y}) divided by the orthogonal acceleration (a_{z}). Exemplary equation 1 illustrates how the surface inclination value can be calculated:

$$θ = arctan ( \frac{{a}_{y}}{{a}_{z}} ) \qquad ( Equation 1 )$$

After determining the surface inclination value, the device stores the surface inclination value in a data storage device (425). For example, the data storage device could be a first-in, first-out (FIFO) buffer. The FIFO buffer can have a predetermined length corresponding to a length of a digital filter, further described below.

After the buffer is full or has sufficient information, the device can apply a digital filter (430) to the buffer containing the stored surface inclination values. In some embodiments, the digital filter can be used to determine a final surface inclination value (θ_{final}) by multiplying each stored inclination value by a predetermined filter coefficient and summing the results. For example, the digital filter can be implemented according to exemplary Equation 2:

θ_{final}=Σᵢ₌₁^{N}θᵢXᵢ (Equation 2)

In Equation 2, θᵢ corresponds to one or more stored surface inclination values and Xᵢ corresponds to one or more predetermined coefficients of the digital filter. The generation of the predetermined filter coefficients is further described below. It is also appreciated that the digital filter described above is illustrative only and other known types of digital filters can be used.

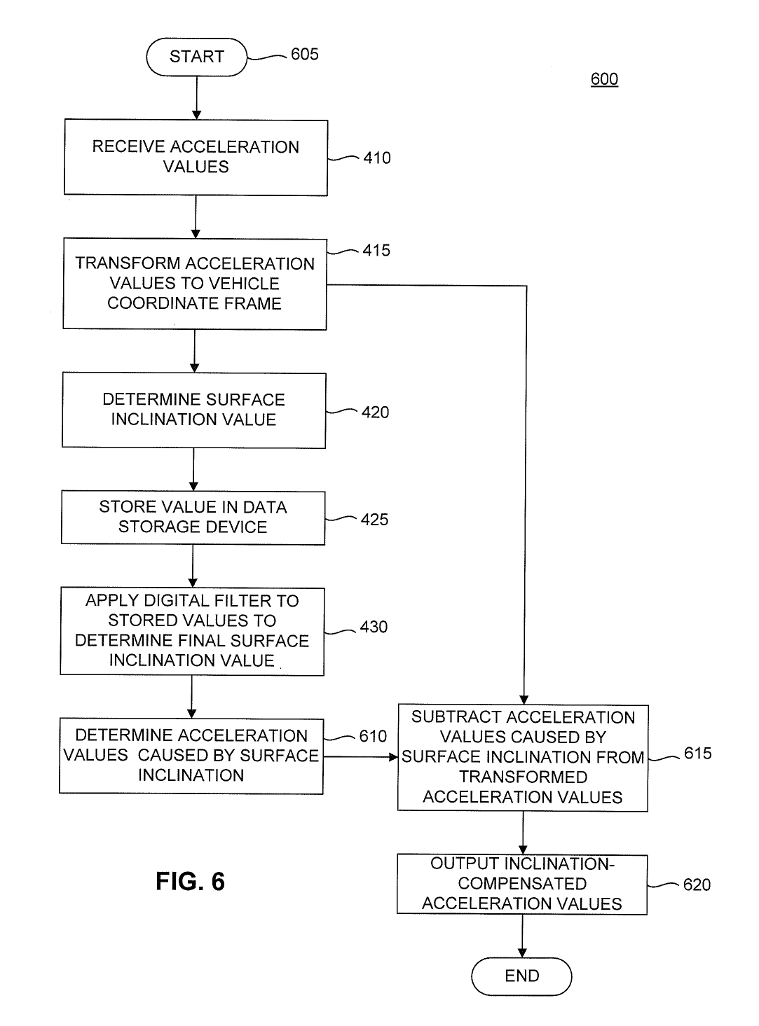

After applying the digital filter, the device can output the final surface inclination value (θ_{final}). In some embodiments, the final surface inclination value (θ_{final}) can be outputted to a user for future use. In some embodiments, the device can output the final surface inclination value (θ_{final}) to be stored locally or to be wirelessly transmitted to a data collection facility. And, in some embodiments, the device can output the final surface inclination value (θ_{final}) for use in another method, such as the method described in FIG. 6, to compensate for acceleration caused by surface inclination (θ).

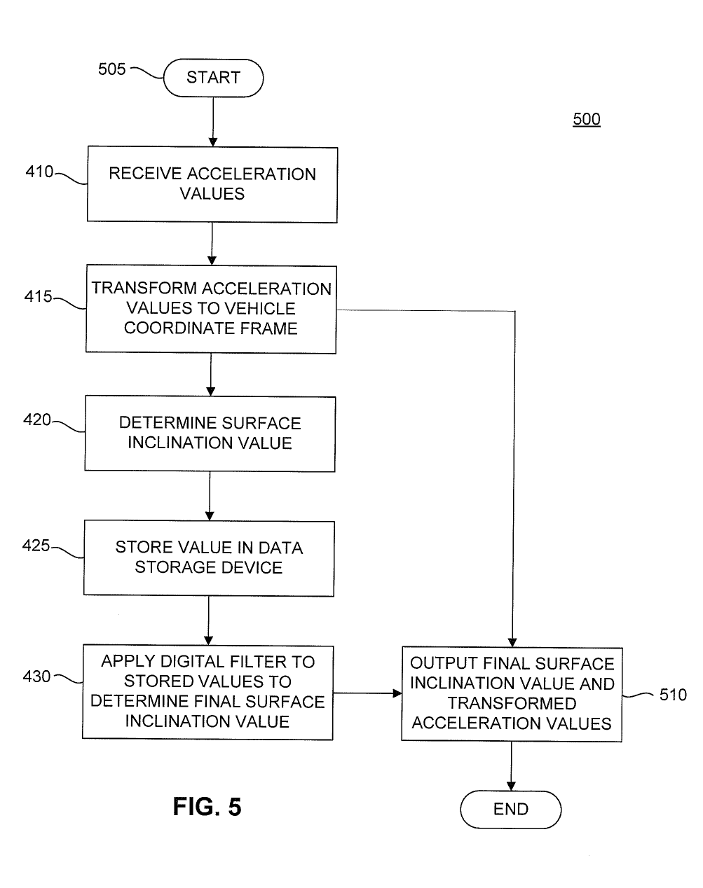

FIG. 5 is a flowchart illustrating an exemplary method 500 for determining one or more final surface inclination values and one or more transformed acceleration values, consistent with embodiments of the present disclosure. The illustrated method is not exhaustive and can be altered to delete steps or further include additional steps. Method 500 can be performed, for example, by an analysis component (e.g., analysis component 200 as described in FIGS. 2A and 2B), by a device incorporating or receiving information from an analysis component (e.g., device 300 as described in FIG. 3), other devices, or any combination thereof. For purposes of simplicity and without limiting the scope of the disclosure, method 500 will be described as being performed by the device.

Method 500 can include several steps from FIG. 4. For example, similar to FIG. 4 described above, the device performing method 500 can receive acceleration values (410), transform the acceleration values (415), determine a surface inclination value using the transformed acceleration values (420), store the surface inclination value in a data storage device (425), and apply a digital filter to one or more stored values to determine a final surface inclination value (430).

Moreover, the device can output one or more final surface inclination values and the one or more transformed acceleration values (510). In some embodiments, the final surface inclination values and transformed acceleration values can be outputted to a user for future use. For example, the one or more final surface inclination values and the one or more transformed acceleration values could be used to provide information showing operator behavior. In other embodiments, the device can output the final surface inclination values and transformed acceleration values to be stored locally or to be wirelessly transmitted to a data collection facility. And, in some embodiments, the device can output the final surface inclination values and transformed acceleration values for use in another method, such as the method described in FIG. 6, to compensate for acceleration caused by the surface inclination (θ).

FIG. 6 is a flowchart illustrating an exemplary method 600 for determining one or more inclination-compensated acceleration values, consistent with embodiments of the present disclosure. The illustrated method is not exhaustive and can be altered to delete steps or further include additional steps. Method 600 can be performed, for example, by an analysis component (e.g., analysis component 200 as described in FIGS. 2A and 2B), by a device incorporating or receiving information from an analysis component (e.g., device 300 as described in FIG. 3), other devices, or any combination thereof. For purposes of simplicity and without limiting the scope of the disclosure, method 600 will be described as being performed by the device.

Method 600 can include several steps from FIG. 4. For example, similar to FIG. 4 described above, the device performing method 600 can receive acceleration values (410), transform the acceleration values (415), determine a surface inclination value using the transformed acceleration values (420), store the surface inclination value in a data storage device (425), and apply a digital filter to one or more stored values to determine a final surface inclination value (θ_{final}) (430).

Moreover, after determining the final surface inclination value (θ_{final}), the device can determine acceleration values caused by the surface inclination (610). The device can determine the effect of the surface inclination on inline acceleration by, for example, multiplying the force of gravity by the sine of the final surface inclination value (θ_{final}). The device can also determine the effect of the surface inclination on orthogonal acceleration by, for example, multiplying the force of gravity by the cosine of the final surface inclination value (θ_{final}). The following exemplary equations illustrate how the compensated accelerations can be calculated:

α_{y,θ}=F_{g} sin θ_{final} (Equation 3)

α_{z,θ}=F_{g} cos θ_{final} (Equation 4)

In Equation 3, a_{y,θ} represents the effect of the surface inclination on inline acceleration, whereas, in Equation 4, a_{z,θ} represents the effect of the surface inclination on orthogonal acceleration. In both equations, F_{g} represents the force of gravity.

After determining the acceleration values using the final surface inclination value (θ_{final}) (610), the device can subtract the acceleration values caused by the surface inclination from the transformed acceleration values (615). The subtraction step 615 can remove the effect of the surface inclination on the transformed acceleration values.

The device can then output the inclination-compensated acceleration values (620). The outputted values can more accurately reflect accelerations caused by operator behavior, compensating for an inclination on, for example, a hill. In some embodiments, the inclination-compensated acceleration values can be outputted to a user for future use. In other embodiments, the device can output the inclination-compensated acceleration values to be stored locally or to be wirelessly transmitted to a data collection facility. And, in some embodiments, the device can output the final surface inclination value and the inclination-compensated acceleration values for use in another method, such as a method for determining driver aggressiveness.

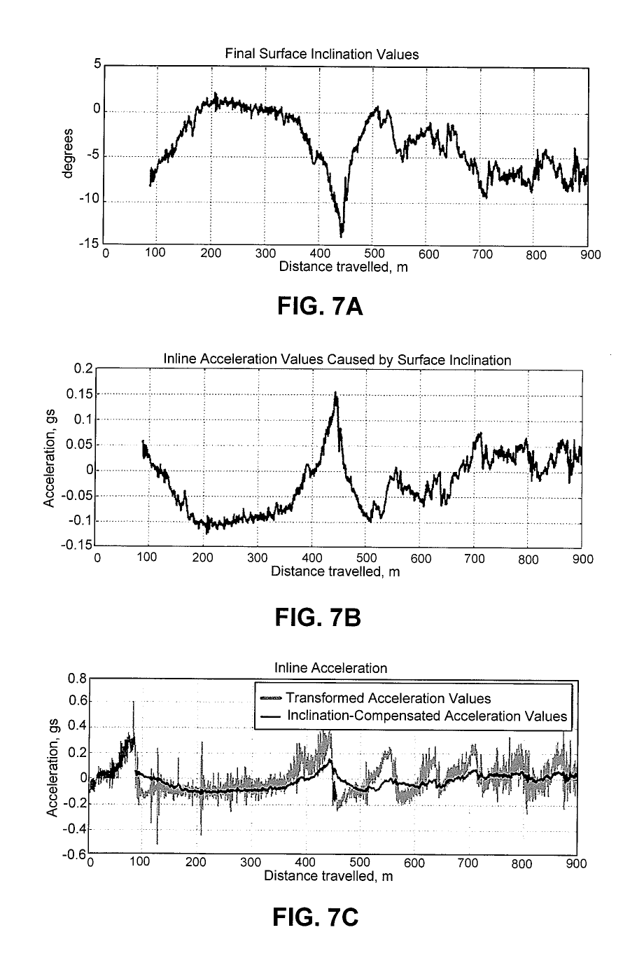

FIGS. 7A-7C illustrate exemplary charts according to a sample set of acceleration values. The signals shown in these figures correspond to the final surface inclination value (θ_{final}) (FIG. 7A), inline acceleration values (a_{y}) caused by the surface inclination (FIG. 7B), transformed inline acceleration values (FIG. 7C) and inclination-compensated inline acceleration values (FIG. 7C).

FIG. 7A shows calculated final surface inclination values (θ_{final}) for a particular surface. This particular surface can correspond to a specific route driven by vehicle 100. In some embodiments, these final surface inclination values (θ_{final}) can be calculated by the method described in FIG. 4.

FIG. 7B shows the inline acceleration values (a_{y}) caused by the corresponding final surface inclination values (θ_{final}). In some embodiments, this inline acceleration (a_{y}) can be determined by the method described in FIG. 6.

The grey sequence of values in FIG. 7C corresponds to transformed inline acceleration values (e.g., the transformed acceleration values in step 415). These acceleration values include acceleration values caused by the surface inclination and acceleration values caused by operator behavior. On the other hand, the black sequence of values in FIG. 7C corresponds to inclination-compensated acceleration values. In some embodiments, the inclination-compensation inline acceleration values can be determined by the method described in FIG. 6. The black sequence of values is representative of acceleration caused by operator behavior with the effect of acceleration caused by surface inclination removed. The black sequence of values in FIG. 7C can therefore more accurately represent acceleration caused by operator behavior.

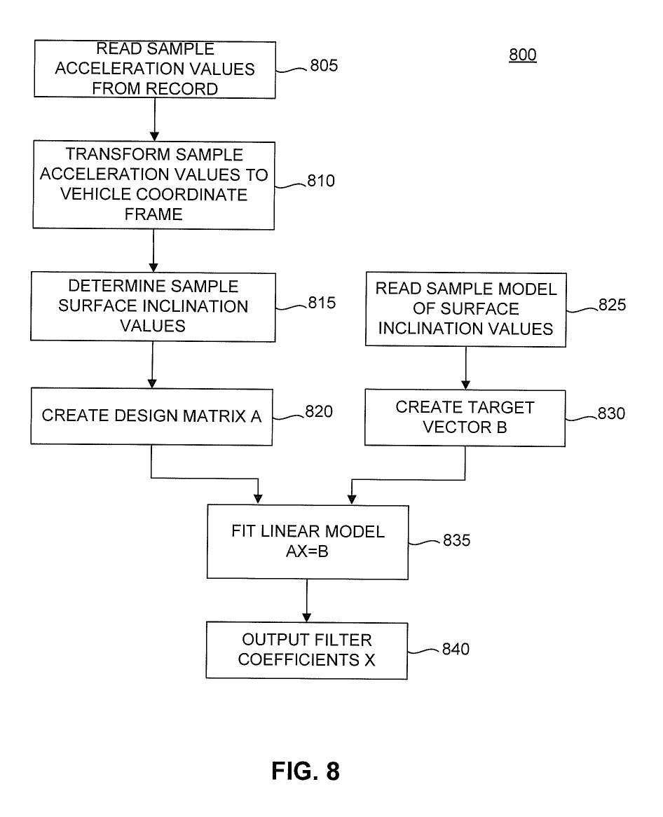

FIG. 8 is a flowchart illustrating an exemplary method 800 for determining coefficients of a digital filter used in determining a final surface inclination value, consistent with embodiments of the present disclosure. The illustrated method is not exhaustive and can be altered to delete steps or further include additional steps. Method 800 can be performed, for example, by an analysis component (e.g., analysis component 200 as described in FIGS. 2A and 2B), by a device incorporating or receiving information from an analysis component (e.g., device 300 as described in FIG. 3), other devices, or any combination thereof. For purposes of simplicity and without limiting the scope of the disclosure, method 800 will be described as being performed by the device.

The device can begin by reading previously recorded sample acceleration values (805). For example, these previously recorded sample acceleration values can be the sample acceleration values stored in step 1120 of method 1100, further described below.

After reading the sample acceleration values, in some embodiments, the device can transform the sample acceleration values (810) to vehicle coordinate frame 130. Alternatively, in some embodiments, the sample acceleration values may not be transformed. For example, the sample acceleration values may have already been transformed to vehicle coordinate frame 130 before they were recorded or an accelerometer that provided the sample acceleration values may have been physically aligned with vehicle coordinate frame 130, making transformation of the sample acceleration values to vehicle coordinate frame 130 maybe unnecessary. The transformed sample acceleration values can correspond to the inline acceleration (a_{y}) and the orthogonal acceleration (a_{z}) of vehicle 100

The device can then determine a plurality of sample surface inclination values (815) using the transformed sample acceleration values. These sample surface inclination values can be calculated by determining the arctangent of the inline acceleration (a_{y}) divided by the orthogonal acceleration (a_{z}), as shown above in Equation 1. Using the sample surface inclination values, the device can create a design matrix A (820). For example, sample surface inclination values can populate design matrix A in the following manner:

$$A = [ \begin{matrix}{θ}_{0} & {θ}_{1} & {θ}_{2} & ⋯ & {θ}_{m - 1} \\ {θ}_{1} & {θ}_{2} & {θ}_{3} & ⋯ & {θ}_{m} \\ {θ}_{2} & {θ}_{3} & {θ}_{4} & ⋯ & {θ}_{m + 1} \\ ⋮ & ⋮ & ⋮ & ⋱ & ⋮ \\ {θ}_{n - 1} & {θ}_{n} & {θ}_{n + 1} & ⋯ & {θ}_{n + m - 2}\end{matrix} ] \qquad ( Equation 5 )$$

In Equation 5, each θ can represent a sample surface inclination value. For example, θ₀ can represent the current sample surface inclination value, θ₁ can represent a sample surface inclination value that is one sample old, θₙ₋₁ can represent a sample surface inclination value that is n−1 samples old, and so forth.

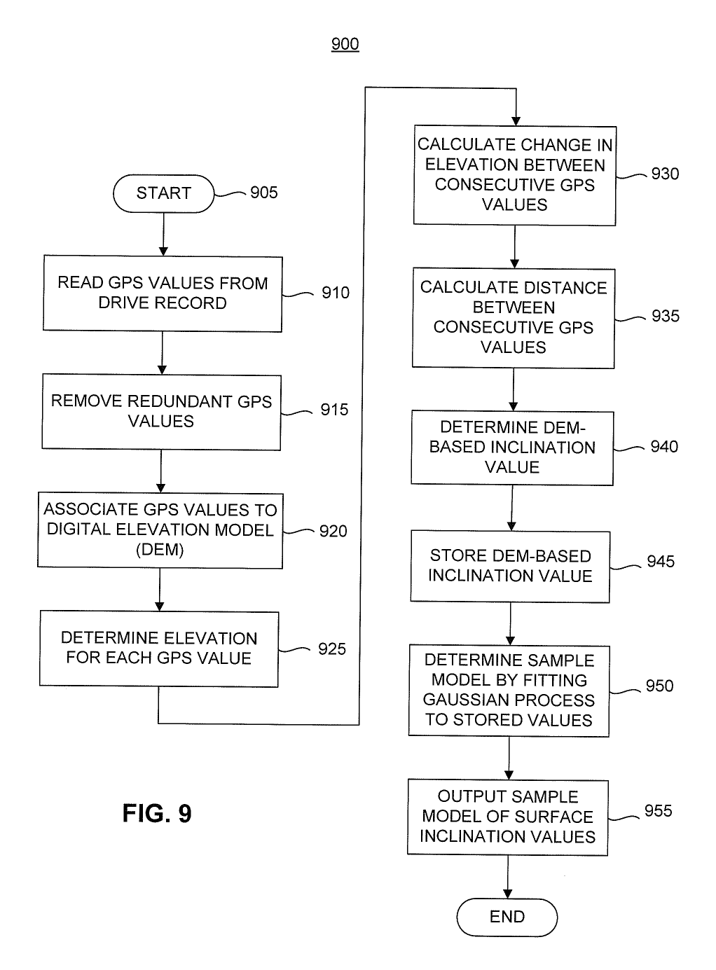

The device can also read a sample model of surface inclination values (825). In some embodiments, this sample model may represent predicted surface inclination values for a particular surface or a particular geographic area. This sample model can be created, for example, by the method described in FIG. 9 below.

Using the sample model of surface inclination values, the device can create a target vector B (830). In some embodiments, the target vector B could represent a vector of predicted surface inclination values generated from the non-accelerometer-based inclination model. After creating design matrix A and target vector B, the device can fit a linear model (835) to the equation represented by AX=B, resulting in a set of filter coefficients (X). In some embodiments, the device can determine the filter coefficients by a least-squares method. For example, in some embodiments, the device can calculate the Moore-Penrose pseudo inverse of matrix A. Solving this system by a least-squares method is presented here as an illustrative example. Other modeling approaches or prediction schemes can be used, including, for example, artificial neural networks, support vector machines, logistic regression, or Gaussian Process regression.

After the fit step 835, the device can output the filter coefficients X (840), which can assist with determining one or more final surface inclination values. In some embodiments, the filter coefficients can be outputted to a user for future use. In other embodiments, method 800 can output the filter coefficients to be stored locally or to be wirelessly transmitted to a data collection facility. And, in some embodiments, the filter coefficients can be outputted for use in another method, such as, for example, for use in filter step 430 described in FIG. 4.

FIG. 9 is a flowchart illustrating an exemplary method 900 for creating a model using sample surface inclination values for use in the creation of a digital filter, consistent with embodiments of the present disclosure. The illustrated method is not exhaustive and can be altered to delete steps or further include additional steps. Method 900 can be performed, for example, by an analysis component (e.g., analysis component 200 as described in FIGS. 2A and 2B), by a device incorporating or receiving information from an analysis component (e.g., device 300 as described in FIG. 3), other devices, or any combination thereof. For purposes of simplicity and without limiting the scope of the disclosure, method 900 will be described as being performed by the device.

The device can begin by reading GPS values that had been previously recorded for a specific route (910). After reading the GPS values, the device can remove redundant GPS values (915). Redundant GPS values may result when, for example, the device samples the GPS at a rate higher than the rate at which the GPS values change. For example, redundant GPS values could result when GPS data is sampled while vehicle 100 is stationary.

After removing step 915, the device can associate the remaining GPS values with elevations in a digital elevation model (DEM) (920). DEMs can include tiles containing elevation above sea level data for particular geographic areas. In some embodiments, the device could consider the projection system used by the GPS and the projection system used in developing the DEM when associating the GPS values with elevations in the DEM. After association step 920, the device can determine an elevation for each GPS value (925). For example, the device can sample the elevation of the DEM tile in the DEM associated with that GPS value.

The device can also calculate the change in elevation between consecutive GPS values (930). In some embodiments, the device can calculate the difference in elevation between the DEM tiles corresponding to the consecutive GPS values. The device can also calculate the distance between consecutive GPS values (935). When calculating this distance, the device may consider the projection system used by the GPS.

After calculating the distance between consecutive GPS values in step 935, the device can determine a DEM-based inclination value (940). For example, the device can calculate the arctangent of the change in elevation of consecutive GPS values divided by the distance between the consecutive GPS values. The following exemplary equation illustrates how the DEM-based inclination can be calculated:

$${θ}_{DEM} = arctan ( \frac{{DEMtile}_{i} - {DEMtile}_{i - 1}}{distanceTravelled} ) \qquad ( Equation 6 )$$

In Equation 6, each DEMtile corresponds to an elevation corresponding to specific GPS coordinates. After determining the DEM-based inclination value (940), the device can store that value in a data storage device (945). In some embodiments, this data storage device can be a FIFO buffer of a predetermined length.

After the buffer is full or has sufficient information, the device can determine a sample model by fitting a Gaussian Process to the stored values to create a model of surface inclination values (950). In some embodiments, the Gaussian Process could be used to smooth the DEM-based inclination values for use in the sample model. In addition, in some embodiments, the device can use the Gaussian Process to generate confidence intervals, such as, for example, ninety five percent confidence intervals. It is also appreciated that the Gaussian Process described above is illustrative only and other known modeling frameworks can be used.

The device can then output the sample model of surface inclination values (955). In some embodiments, the device can output the sample model to a user for future use. For example, a user can develop a more accurate filter, such as the filter used in step 430 described above, with the sample model. In some embodiments, the device can output the sample model to be stored locally or to be wirelessly transmitted to a data collection facility. And, in some embodiments, the device can output the sample model for use in another method, such as the method described in FIG. 8, to determine filter coefficients.

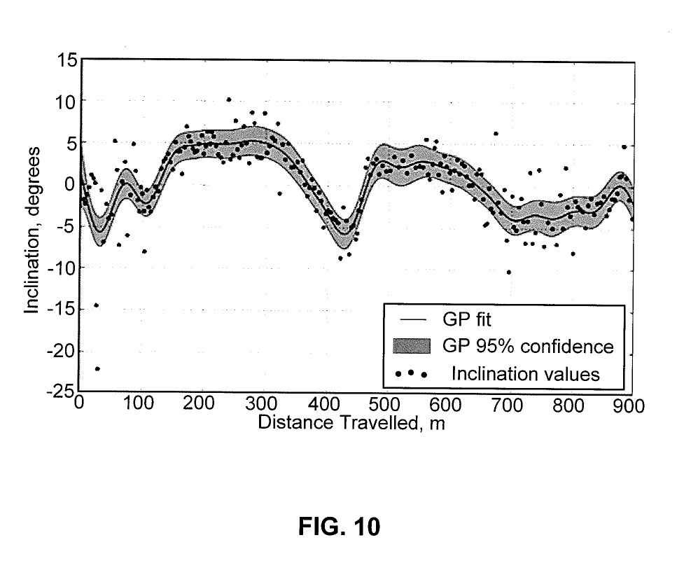

FIG. 10 is an exemplary chart illustrating a sample model created by a Gaussian Process fitted to a sample set of inclination values, consistent with embodiments of the present disclosure. In FIG. 10, the sequence of data points corresponds to the sample inclination values. For example, the sample inclination values could be DEM-based inclination values determined according to the method described in FIG. 9 above. FIG. 10 also shows a solid line that corresponds to a best fit of the sample inclination values. The best fit corresponds to the sample model of surface inclination values described above. In some embodiments, this best fit can be determined by a Gaussian Process. In addition, the Gaussian process can determine confidence intervals, such as, for example, ninety-five percent confidence intervals, which are indicated in FIG. 10 by the shaded region.

In some embodiments, an appropriate length scale could be selected before fitting the Gaussian Process to the sample inclination values. In some embodiments, the appropriate length scale could correspond to the type of landscape over which vehicle 100 is traveling. For example, a short length scale, such as one meter, may over-fit quick variations in elevation, resulting in a best fit or sample model that does not accurately represent the landscape. To counteract this effect, a longer length scale could be used. In some embodiments, a length scale between 100 meters and 1000 meters could be used. And in some embodiments, the length scale could be chosen to correspond to a certain environment. For example, a longer length scale could be used when changes in elevation are more gradual (e.g. driving through the plains), and a shorter length scale could be used when the environment contains more varied topography (e.g., driving through the mountains).

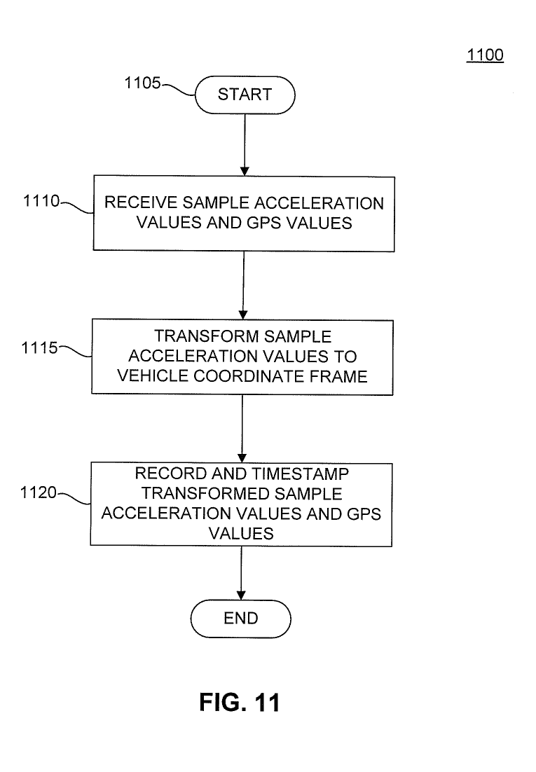

FIG. 11 is a flowchart illustrating an exemplary method 1100 for recording sample accelerometer values and GPS values for use in developing the sample model, consistent with embodiments of the present disclosure. The illustrated method is not exhaustive and can be altered to delete steps or further include additional steps. Method 1100 can be performed, for example, by an analysis component (e.g., analysis component 200 as described in FIGS. 2A and 2B), by a device incorporating or receiving information from an analysis component (e.g., device 300 as described in FIG. 3), other devices, or any combination thereof. For purposes of simplicity and without limiting the scope of the disclosure, method 1100 will be described as being performed by the device.

The device can begin by receiving sample acceleration values and GPS values (1110). In some embodiments, the device can receive sample acceleration values by sampling an accelerometer (e.g., accelerometer 120 as described in FIG. 1). In some embodiments, the accelerometer can transmit acceleration values to the device. The device can also receive GPS values from a GPS sensor. In some embodiments, the GPS sensor can be located in or on vehicle 100. In some embodiments, the GPS sensor can be integrated with the device. And in some embodiments, the GPS sensor can be part of another device.

In some embodiments, the device can transform the sample acceleration values (1115), aligning the sample acceleration values with the axes of a vehicle coordinate (e.g. vehicle coordinate frame 130 as described in FIG. 1). In some embodiments, the transformation step 1115 is not needed. For example, a transformation step may not be needed if the axes of the accelerometer are already physically aligned with the axes of the vehicle coordinate frame. The device can also record and timestamp the transformed sample acceleration values and the GPS values (1120). For example, the device can time stamp and record the transformed sample acceleration values and the GPS values to correlate the transformed acceleration values with the GPS values.

To obtain accurate sample acceleration values representing different driving conditions, method 1100 can be performed on a wide variety of driving scenarios. For example, method 1100 can be performed on different landscapes, such as, for example, flat areas and hilly areas. Method 1100 can also be performed with a variety of vehicles, such as, for example, automobiles, bicycles, motorcycles, all-terrain vehicles, trains, watercrafts, or planes. Moreover, method 1100 can be performed during different traffic conditions, such as, for example, when traffic is heavy.

In the preceding specification, various preferred embodiments have been described with reference to the accompanying drawings. It will, however, be evident that various modifications and changes can be made thereto, and additional embodiments can be implemented, without departing from the broader scope of the subject matter as set forth in the claims that follow. The specification and drawings are accordingly to be regarded in an illustrative rather than restrictive sense.

What is claimed is:

1. A system comprising:
an accelerometer; and
an analysis component configured to:
determine a plurality of surface inclination values, wherein the surface inclination values are based on acceleration values received from the accelerometer;
store the surface inclination values;
determine, based on the stored surface inclination values, a final surface inclination value; and
output the final surface inclination value.

2. The system of claim 1, wherein the analysis component is further configured to:
determine a plurality of products, wherein the products are the result of multiplying the surface inclination values by filter coefficients;
sum the products; and
output the sum.

3. The system of claim 2, wherein the analysis component is further configured to:
record a plurality of GPS values;
record a plurality of sample acceleration values;
determine a plurality of elevation values, wherein the elevation values are based on referencing a digital elevation model (DEM) for the recorded GPS values;
determine, based on the elevation values, a plurality of DEM-based inclination values;
determine, based on the recorded sample acceleration values, a plurality of sample surface inclination values;
fit a model to the DEM-based inclination values and the sample surface inclination values; and
output coefficients of the model.

4. The system of claim 3, wherein the analysis component determines the DEM-based inclination values by calculating an arctangent of a change in elevation values between consecutive DEM tiles divided by a distance between the consecutive DEM tiles.

5. The system of claim 3, wherein the model is a linear model and the model is determined by a least squares method.

6. The system of claim 3, wherein the analysis component is further configured to apply a Gaussian Process to the DEM-based inclination values.

7. The system of claim 1, wherein the analysis component is further configured to:
transform the acceleration values to a coordinate frame of a vehicle;
determine, based on the final surface inclination value, a first force and a second force;
determine a plurality of compensated acceleration values, wherein the compensated acceleration values are determined by subtracting the forces from the transformed acceleration values; and
output the compensated acceleration values.

8. The system of claim 7, wherein the analysis component is further configured to provide information showing a behavior of an operator of the vehicle based on the compensated acceleration values.

9. A system comprising:
an analysis component including one or more processors configured to:
determine a plurality of surface inclination values, wherein the surface inclination values are based on acceleration values received from an accelerometer;
store the surface inclination values;
determine, based on the stored surface inclination values, a final surface inclination value; and
output the final surface inclination value.

10. The system of claim 9, wherein the analysis component is further configured to:
transform the acceleration values to a coordinate frame of a vehicle;
determine, based on the final surface inclination value, a first force and a second force;
determine a plurality of compensated acceleration values, wherein the compensated acceleration values are determined by subtracting the forces from the transformed acceleration values; and
output the compensated acceleration values.

11. The system of claim 10, wherein the analysis component is further configured to provide information showing a behavior of an operator of the vehicle based on the compensated acceleration values.

12. A method for determining a surface inclination with respect to a vehicle, the method being performed by one or more processors and comprising:
determining a plurality of surface inclination values, wherein the surface inclination values are based on acceleration values received from an accelerometer;
storing the surface inclination values;
determining, based on the stored surface inclination values, a final surface inclination value; and
outputting the final surface inclination value.

13. The method of claim 12, wherein determining the final surface inclination value comprises:
determining a plurality of products, wherein the products are the result of multiplying the surface inclination values by filter coefficients;
summing the products; and
outputting the sum.

14. The method of claim 13, wherein the filter coefficients are determined by:
recording a plurality of GPS values;
recording a plurality of sample acceleration values;
determining a plurality of elevation values, wherein the elevation values are based on referencing a digital elevation model (DEM) for the recorded GPS values;
determining, based on elevation values, a plurality of DEM-based inclination values;
determining, based on the recorded sample acceleration values, a plurality of sample surface inclination values;
fitting a model to the DEM-based inclination values and the sample surface inclination values; and
outputting coefficients of the model.

15. The method of claim 14, wherein the DEM-based inclination values are determined by calculating an arctangent of a change in elevation values between consecutive DEM tiles divided by a distance between the consecutive DEM tiles.

16. The method of claim 14, wherein the model is a linear model and the model is determined by a least squares method.

17. The method of claim 14, further comprising applying a Gaussian Process to the DEM-based inclination values.

18. The method of claim 12, further comprising:
transforming the acceleration values to a coordinate frame of the vehicle;
determining, based on the final surface inclination value, a first force and a second force;
determining a plurality of compensated acceleration values, wherein the compensated acceleration values are determined by subtracting the forces from the transformed acceleration values; and
outputting the compensated acceleration values.

19. The method of claim 18, further comprising providing information showing a behavior of an operator of the vehicle based on the compensated acceleration values.

20. The method of claim 19, wherein the information showing the behavior of the operator is used to adjust an insurance rating model.
